(19) United States
(12) Patent Application Publication
(10) Pub. No.: US 2013/0091302 A1
(43) Pub. Date: Apr. 11, 2013

(54) SECURE PERSONAL MOBILE-TO-MOBILE INFORMATION EXCHANGE USING INTERLOCKED CAMERA PROTOCOL

(71) Applicant: Martin R. Roscheisen, San Francisco, CA (US)

(72) Inventor: Martin R. Roscheisen, San Francisco, CA (US)

(21) Appl. No.: 13/253,882

(22) Filed: Oct. 5, 2011

(51) Int. Cl. G06F 15/16

(52) U.S. Cl. 709/237

(57) ABSTRACT

Information may be transferred directly between two mobile electronic devices where each device has a display and a camera on the same side. Data may be converted into one or more images using a processor on a first mobile communication device. The images may be displayed on a display on the first mobile communication device. The images are configured to convey information in a form that is detectable by a camera built into a second mobile communication device and interpretable by computer executable instructions running on a processor coupled to the camera that is built into the second mobile communication device. Images displayed on a display of the second device may be detected with a camera on the first device. The images on the second device's display may be interpreted to convert information encoded within those images into electronic data using the processor on the first device.

### FIELD OF THE INVENTION

Embodiments of the invention relate to mobile communication devices and more specifically to direct communication between mobile communication devices having display screens and cameras.

### BACKGROUND

This section describes background subject matter related to the disclosed embodiments of the present invention. There is no intention, either express or implied, that the background art discussed in this section legally constitutes prior art.

Mobile communication devices have become increasingly common since the development of the first cellular telephone. Mobile communication devices now encompass devices that can send and receive electronic mail, access computer networks, such as the internet, and provide traditional cellular telephone communications. Most communication between such mobile devices utilizes an intermediary, such as a computer or telephone network. However, since the parties at either end of the communication typically do not control the intermediary network, there is always a question as to the reliability and security of such communications.

Transferring information from one mobile device to another—a Sender to a Receiver—is a key application for mobile devices. Examples include transfer of images, electronic cash tokens, business cards from an iPhone to an Android phone. As used herein, the term “direct transfer” refers to transfer happening without the help of a network connection. Direct transfer has the advantage of not requiring an active network connection at the point of time of the transfer. High-bandwidth transfer, which may be defined as transferring more than 1 Mbit per second, is useful for transferring high-resolution images.

Handshake transfer, which may be defined as the Sender receiving feedback that the information was successfully received by the Receiver, is useful for transferring electronic cash tokens and other information.

Secure transfer, which may be defined as ensuring that a piece of information cannot be intercepted by another device and has exactly only been transferred one and only one time, is useful and required for transferring electronic cash tokens and other important information.

State of the art direct transfer solutions that are not based on network connectivity are often based on Near Field Communication (NFC) and related protocols. NFC capabilities are being built into many of the latest mobile phones and devices. However, the user experience for NFC is such that users cannot know whether surrounding devices listen in to the communication and the device user cannot intentionally direct the device towards communicating with another device by virtue of physically directing the device towards the device with which it is supposed to communicate. Furthermore, NFC is not implemented in every device, including legacy devices.

It would be useful to provide a new way of communicating directly between two devices is necessary that preferably works at a high-bandwidth, in a secure way without requiring network connectivity at all times and that can work with legacy smartphone hardware through software upgrades only.

It is within this context that embodiments of the present invention arise.

### SUMMARY

Embodiments of the present invention address the above-described problems with direct transfer of data through the use of an “interlocked camera” protocol that takes advantage of the fact that many communication devices include both a display and a camera.

### BRIEF DESCRIPTION OF THE DRAWINGS

FIG. 1 is a schematic diagram illustrating an example of direct transfer of information between mobile communication devices in accordance with an embodiment of the present invention.

FIG. 2 is a flow diagram illustrating a method of direct transfer of information between mobile communication devices in accordance with an embodiment of the present invention.

FIG. 3 is a block diagram illustrating a mobile communication device in accordance with an embodiment of the present invention.

FIG. 4 is a schematic diagram illustrating an example of an alignment element that may be used to facilitate transfer of information in accordance with embodiments of the present invention.

### DETAILED DESCRIPTION

As a preface to the detailed description, it should be noted that, as used in this specification and the appended claims, the singular forms “a”, “an”, and “the” include plural referents, unless the context clearly dictates otherwise.

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” “above”, “below”, etc., is used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

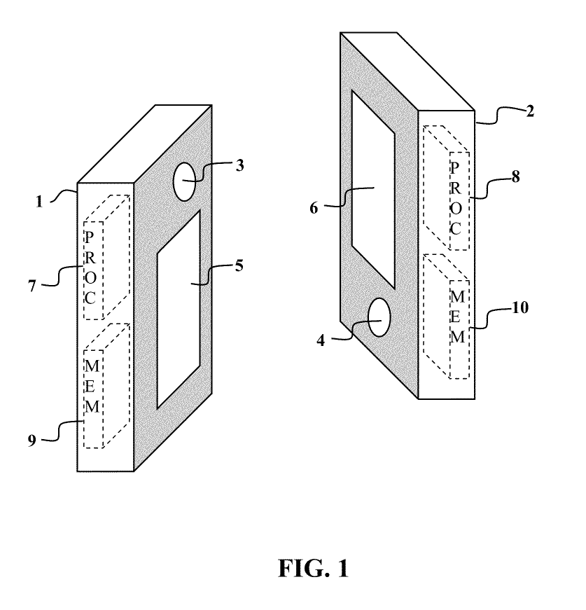

Embodiments of the present work with mobile devices that have a display and a camera built in to the same side of the device as the display. As seen in FIG. 1, two such devices 1, 2 can be held against each other so that a first device's camera 3 can see a second device's display 6 and the second device's camera 4 can see the first device's display 5. Each device may include a processor 7, 8 and memory 9, 10 coupled to the corresponding camera and display. The processors 7, 8 can be configured, e.g., by execution of suitable program instructions, to display a rapid sequence of images in response to each other to implement a communications protocol. This communications protocol may include an initiation handshake (telling each other of one's presence and kicking off the transfer communication), a handshake on the security method to be used, a handshake on the relevant application (e.g., contact information transferred for address book or another application, such as transfer of photo information for a photo album; transfer of electronic cash tokens for an e-commerce application, etc.); and an information stream including error detection fields.

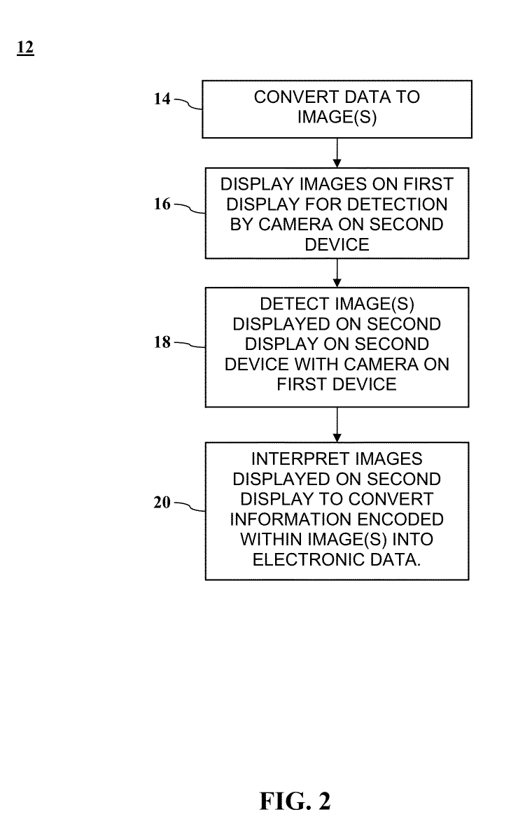

By way of example FIG. 2, depicts a flow diagram that illustrates a process 12 for transferring information directly between two mobile electronic devices. As seen in FIG. 1, each device has a display and a camera on the same side as the device's display. As indicated at 14 data may be converted into one or more images using a processor on a first mobile communication device. For example data stored in the memory 9 of first device 1 may be converted to an image by execution of instructions running on the processor 7 of the first device 1.

The images may then be displayed on the display 5 of the first device 1 as indicated at 16. The image(s) may be configured to convey information in a form that is detectable by the camera 4 on the second mobile communication device 2 and interpretable by computer executable instructions running on the processor 8 in the second mobile communication device 2.

It is noted that the second device may similarly convert data stored in the memory 10 into images that can be displayed on the display 6. The images displayed on the display 6 of the second device 2 can be detected with the camera 3 on the first device as indicated at 18. By way of example, and not by way of limitation, the data may be encoded in the images as a pattern code, such as a bar code or two dimensional (2D) code. There are numerous publicly available pattern codes.

The processor 7 on the first device 1 may then and interpret the images shown on the display 6 of the second device 2 to convert information encoded within those images into electronic data using suitably configured software. The processor 7 may interpret the images by analyzing them with suitable pattern code reader software as indicated at 20.

The process shown in FIG. 2 may be repeated with each device responding to data coded into the images displayed by the other device, e.g., to implement handshake transfer or secure transfer.

Each image transferred may include a parallel display of multiple communication elements in tiles within an image, with each tile having a certain function. For example, each image may include a rotational alignment element (allowing the devices to know of the three-dimensional, possibly perspective alignment of the devices to each other, for use in image recognition and analysis), a Received Status element (for the Receiver to indicate that a certain image was received) as well as a Sequence element (indicating the step of transmission).

While the Sender device displays an image on its display, the Receiver device can record the image it using its camera and display its reception status in the Received Status element. It is noted that in the example illustrated in FIG. 1 and FIG. 2, both the first device 1 and the second device 2 may act as Sender and Receiver, so that two-way communication may be established between the devices. It is noted that this two-way communication can be implemented without requiring either device to communicate with an external network. Communication can therefore be made robust and secure.

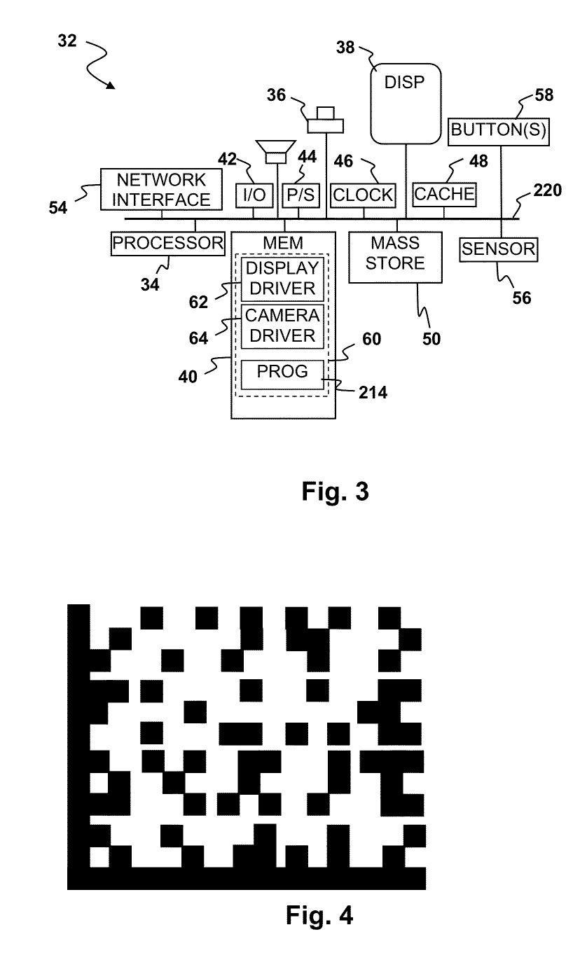

Embodiments of the present invention can be implemented with many types of existing mobile communication devices having a few common components. By way of example, and not by way of limitation, as seen in FIG. 3, a mobile communication device 32 may include a processor 34 operably coupled to a visual display 36, a camera 38 and a memory 40 (e.g., RAM, DRAM, ROM, and the like). The processor and memory may be housed within a case (not shown). As noted above, the display 36 and camera 38 are located on the same side of the device, e.g., on the same side of the case. In some embodiments, the device 32 may include multiple processors 34, e.g., if parallel processing is to be implemented. The device 32 may be configured for use as a game device, a phone, a portable media player, an email device, web browser device and the like.

The mobile communication device 32 may also include well-known support functions, such as input/output (I/O) elements 42, power supplies (P/S) 44, a clock (CLK) 46 and cache 48. The device 32 may optionally include a mass storage device 50 such as a disk drive, CD-ROM drive, flash drive, or the like to store programs and/or data. The processor 34, display 36, camera 38, memory 40 and other components of the device 32 may exchange signals (e.g., code instructions and data) with each other via a system bus 52 as shown in FIG. 3. In some embodiments, the device 32 may include an optional network interface 54, configured to allow the device to exchange signals with other devices over a network. Furthermore, the device 32 may include one or more sensors 56. Such sensors may include, e.g., an inertial sensor such as an accelerometer or tilt sensor, an optical sensor, temperature sensor, or an acoustic sensor such as a microphone or microphone array.

The display 36 may be any suitable form of display capable of presenting visible symbols and/or graphical images. By way of example the visual display 36 may include a flat panel display, such as a liquid crystal display (LCD) or light emitting diode (LED) display. In some embodiments, the visual display 36 on the front surface may also incorporate a touch sensitive element to provide an interface for receiving user commands. The touch sensitive element may be based on any suitable touch screen technology, such as resistive, surface-acoustic wave (SAW) capacitive, infrared, strain gauge, optical imaging, dispersive signal technology, acoustic pulse recognition, frustrated total internal reflection or graphics tablet based on magneto-strictive technology that responds to the proximity of a user's fingers or a stylus. A visual display having such a configuration is commonly known as a touch screen.

In some embodiments, the device 32 may include one or more optional buttons 58 coupled to the processor 34 to provide additional sources of input. There are a number of different possible configurations for the optional buttons 58. By way of example, and without loss of generality, one or more optional buttons 58 may be located on front surface, back surface, or side edge of the device 32. Furthermore, the buttons may be laid out in any suitable arrangement, e.g., as a telephone keypad or keyboard.

In addition, the device 32 may include one or more audio speakers 59 that produce audible or otherwise detectable sounds. To facilitate generation of such sounds, the device 32 may further include an optional audio processor (not shown) that is adapted to generate analog or digital audio output from instructions and/or data provided by the processor 34, memory 40, and/or storage device 50.

A computer readable medium such as the memory 40 or storage device 50 may store program instructions 60 for execution on the processor 34. The program instructions 60 may be configured to respond to inputs from one or more input sources on the device (e.g., the camera 38, the sensors 56, or buttons 58) and provide outputs to one or more output devices, such as the visual display 36. The program instructions 60 may include display driver instructions 62 configured to generate images displayed on the visual display 62. The program 60 may include camera driver instructions 64 that respond to inputs received from the camera 38. It is noted that in some embodiments, the functions of the visual display 36 and buttons 58 may be combined into a single touch screen interface that may serve as both an input and an output device.

### EXAMPLES

As noted above there are a number of different patterns that may be used to encode data into images that are transferred. These patterns include bar codes and 2D codes. FIG. 4 depicts an example of a pattern for a type of 2D code known as a Data Matrix code.

A Data Matrix code is a two-dimensional matrix barcode consisting of black and white “cells” or modules arranged in either a square or rectangular pattern. The information to be encoded can be text or raw data. The typical data size for a Data Matrix code is from a few bytes up to 1556 bytes. The length of the encoded data depends on the symbol dimension used. Error correction codes may be added to increase symbol strength. By adding error correction codes, even if the image is partially damaged or obscured, it can still be read. A Data Matrix symbol may store up to 2,335 alphanumeric characters.

As may be seen from FIG. 4 Data Matrix symbols are rectangular in shape and usually square. The symbol is made of light and dark cells that represent bits. Depending on the specific implementation a “light” cell may be interpreted as a 0 and a “dark” module may be interpreted as a 1, or vice versa. The Data Matrix typically includes two solid adjacent borders in an “L” shape (called the “finder pattern”) and two other borders consisting of alternating dark and light “cells” or modules (called the “timing pattern”). Within these borders are rows and columns of cells encoding information. The finder pattern is used to locate and orient the symbol while the timing pattern provides a count of the number of rows and columns in the symbol. As more data is encoded in the symbol, the number of cells (rows and columns) increases. Symbol sizes vary from 8×8 cells to 144×144 cells.

Although a Data Matrix is shown as an example, those skilled in the art will recognize that other barcode or 2D barcode patterns may be used.

Embodiments of the present invention may be used to transfer large images can be transferred in high bandwidth and without loss of resolution by stepping through the image in frames. For example, a 1000×1000 pixel image can be displayed by stepping through 100×100 pixel subunits of that large image, 10 per row for 10 rows, in rapid sequence. By displaying 25 frames per second, the large image can be transferred in 4 seconds without loss of resolution.

In other embodiments of the present invention, electronic cash tokens can be transferred through the user of the Sender telling the e-cash application to transmit a certain payment amount in electronic cash tokens, these tokens being displayed by the Sender and transferred to the Receiver, the Receiver acknowledging receipt, and the Sender application securely removing such amount transferred from its electronic cash position.

In further embodiments of the present invention content pieces can be transferred embedded into an information container that can be opened only by Trusted Applications (defined as an application that will adhere to certain usage and other rights in a secure way).

While the above is a complete description of the preferred embodiments of the present invention, it is possible to use various alternatives, modifications, and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for”. Any element in a claim that does not explicitly state “means for” performing a specified function, is not to be interpreted as a “means” or “step” clause as specified in 35USC §112, ¶6.

What is claimed is:

1. A process of transferring information directly between two mobile electronic devices where each device has a display and a camera on the same side as the device's display, the process comprising:
a) converting data into one or more images using a processor on a first mobile communication device;
b) displaying the images on a display on the first mobile communication device, wherein the image is configured to convey information in a form that is detectable by a camera on a second mobile communication device and interpretable by computer executable instructions running on a processor coupled to the camera on the second mobile communication device;
c) detecting one or more images displayed on a display of the second device with a camera on the first device; and
d) interpreting the one or more images displayed on the display of the second device to convert information encoded within the one or more images into electronic data using the processor on the first mobile communication device.

2. The process of claim 1, wherein no network connection to either the first or second device is required to be actively present in order for the transfer of information to take place.

3. The process of claim 1, wherein the one or more images displayed on the display of the first device or the one or more images displayed on the display of the second device includes an alignment element.

4. The process of claim 1, wherein interpreting the one or more images includes using the alignment element to account for a non-parallel alignment between the first mobile communication device.

5. The process of claim 1, wherein displaying the images on the display built in to the first mobile communication device includes display images at a rate faster than 60 images per minute.

6. The process of claim 1, further comprising using an encryption key to verify that applications at the first and second mobile devices involved in the process of transferring the information are trusted applications.

7. The process of claim 1, wherein the transmitted information is embedded in an information container that includes usage rights for the information transferred in a secure way.

8. The process of claim 1, wherein the information encoded within the one or more images is an electronic cash token.

9. The process of claim 1, wherein the information transferred is an image larger than 1 Mbyte in size.

10. A non-transitory computer readable medium having embodied therein computer executable instructions configured to implement a process of transferring information directly between two mobile electronic devices where each device has a display and a camera on the same side as the device's display, the process comprising:
a) converting data into one or more images using a processor on a first mobile communication device;
b) displaying the images on a display on the first mobile communication device, wherein the image is configured to convey information in a form that is detectable by a camera on a second mobile communication device and interpretable by computer executable instructions running on a processor coupled to the camera on the second mobile communication device;
c) detecting one or more images displayed on a display of the second device with a camera on the first device; and
d) interpreting the one or more images displayed on the display of the second device to convert information encoded within the one or more images into electronic data using the processor on the first mobile communication device.

11. The non-transitory computer readable medium of claim 10, wherein no network connection to either the first or second device is required to be actively present in order for the transfer of information to take place.

12. The non-transitory computer readable medium of claim 10, wherein the one or more images displayed on the display of the first device or the one or more images displayed on the display of the second device includes an alignment element.

13. The non-transitory computer readable medium of claim 10, wherein interpreting the one or more images includes using the alignment element to account for a non-parallel alignment between the first mobile communication device.

14. The non-transitory computer readable medium of claim 10, wherein displaying the images on the display built in to the first mobile communication device includes display images at a rate faster than 60 images per minute.

15. The non-transitory computer readable medium of claim 10, further comprising using an encryption key to verify that applications at the first and second mobile devices involved in the process of transferring the information are trusted applications.

16. The non-transitory computer readable medium of claim 10, wherein the transmitted information is embedded in an information container that includes usage rights for the information transferred in a secure way.

17. The non-transitory computer readable medium of claim 10, wherein the information encoded within the one or more images is an electronic cash token.

18. The process of claim 1 where the information transferred is an image larger than 1 Mbyte in size

19. A mobile communication device, comprising:
a display disposed on a side of the device, the display being coupled to the processor and memory;
a camera disposed on the same side of the device as the display;
a processor;
a memory coupled to the processor, the memory having embodied therein computer executable instructions that are executable by the processor, wherein the instructions are configured to implement a process of transferring information directly between the mobile communication device and another mobile communication device having another display and another camera on the same side of the other device as the other display, the process comprising:
a) converting data stored in the memory into one or more images using the processor;
b) displaying the one or more images on the display, wherein each of the one or more images is configured to convey information in a form that is detectable by the camera of the other mobile communication device and interpretable by computer executable instructions running on another processor coupled to the other camera;
c) detecting with the camera one or more images displayed on the other display; and
d) interpreting the one or more images displayed on the other display to convert information encoded within the one or more images displayed on the other display into electronic data using the processor.

20. The mobile communication device of claim 19 wherein no network connection to either the mobile communication device or the other mobile communication device is required to be actively present in order for the transfer of information to take place
